(19) United States
(12) Patent Application Publication
(10) Pub. No.: US 2009/0149128 A1
(43) Pub. Date: Jun. 11, 2009

(54) SUBTITLE INFORMATION TRANSMISSION APPARATUS, SUBTITLE INFORMATION PROCESSING APPARATUS, AND METHOD OF CAUSING THESE APPARATUSES TO COOPERATE WITH EACH OTHER

(76) Inventor: Ichiro Tomoda, Hamura-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/270,053

(22) Filed: Nov. 13, 2008

(30) Foreign Application Priority Data
Dec. 11, 2007 (JP) 2007-320080

(51) Int. Cl. H04B 7/00

(52) U.S. Cl. 455/41.3

(57) ABSTRACT

According to one embodiment, a subtitle information reproduction apparatus includes a reception unit which reproduces a video signal including subtitle information, a closed caption decoding unit which separates text of subtitle information from the video signal, and a Bluetooth communication unit which transmits in stream form the text of subtitle information obtained from the separation unit to the outside.

### CROSS-REFERENCE TO RELATED APPLICATIONS

This application is based upon and claims the benefit of priority from Japanese Patent Application No. 2007-320080, filed Dec. 11, 2007, the entire contents of which are incorporated herein by reference.

### BACKGROUND

1. Field

One embodiment of the present invention relates to a subtitle information transmission apparatus, a subtitle information processing apparatus, and a method of causing these apparatuses to cooperate with each other which handle subtitle information included in a video signal.

2. Description of the Related Art

In U.S. TV broadcasts, subtitle information for people with visual and hearing disabilities called closed captions is inserted into a video signal using the vertical blanking period and others and the resulting signal is transmitted in the form of broadcast waves. The subtitle information is digital text. A television receiver separates the subtitle information from the video signal and displays it together with the image information obtained in the effective scanning line period of the video signal.

In a recording medium, such as a DVD or videotape on which such content as a movie has been recorded, subtitle information is inserted into a video signal (MPEG2 bitstream) and the resulting signal is recorded onto a recording medium. A video player separates the subtitle information from the video signal reproduced from the recording medium and outputs the subtitle information together with the image information obtained from the video signal.

The technique for translating English subtitle information separated from a video signal into Japanese and outputting the translation result together with image information has been known (e.g., refer to, Jpn. Pat. Appln. KOKAI Publication No. 7-250282).

Since the translation result is overlaid on a displayed image on the video display, the number of characters is limited so as not to decrease the viewability of the displayed image. Because of the restriction on the number of characters, it is difficult to display such a detailed explanation as the meaning and usage of an English word. For example, the meaning and usage of an English word can be looked up with an electronic dictionary device. However, troublesome character input operations have to be carried out for each word.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary diagram showing the configuration of a subtitle information processing system according to a first embodiment of the invention;

FIG. 2 is an exemplary diagram showing the transition between display modes of the liquid-crystal display shown in FIG. 1;

FIG. 3 is an exemplary diagram showing an image displayed in the scroll display mode on the liquid-crystal display shown in FIG. 1;

FIG. 4 is an exemplary diagram showing an image displayed in the translation display mode on the liquid-crystal display shown in FIG. 1;

FIG. 5 is an exemplary diagram showing the configuration of a subtitle information processing system according to a second embodiment of the invention;

FIG. 6 is an exemplary diagram showing the configuration of an AVDTP packet generated at a Bluetooth communication unit of a DVD player in a subtitle information processing system according to a third embodiment of the invention;

FIG. 7 is an exemplary diagram showing the configuration of a personal computer provided as a subtitle information processing apparatus in the subtitle information processing system according to the second embodiment of the invention; and

FIG. 8 is an exemplary diagram for explaining software executed by the control unit shown in FIG. 7.

### DETAILED DESCRIPTION

Various embodiments according to the invention will be described with reference to the accompanying drawings.

According to one embodiment of the invention, there is provided a subtitle information transmission apparatus which comprises: a signal reproduction unit which reproduces a video signal including subtitle information; a separation unit which separates text of subtitle information from the video signal; and a short-range wireless communication unit which transmits in stream form the text of subtitle information separated by the separation unit to the outside.

According to one embodiment of the invention, there is provided a subtitle information processing apparatus which comprises: a short-range wireless communication unit which receives text of subtitle information separated from a video signal and transmitted in stream form; a memory unit which holds the text of subtitle information received by the short-range wireless communication unit; a display unit which displays the text held in the memory unit; an operation unit which selects, on a word basis, the text displayed on the display unit; a dictionary unit which holds a dictionary; and a processing unit which searches the dictionary of the dictionary unit for the meaning of the word selected by the operation unit and causes the display unit to display a result of the search.

According to one embodiment of the invention, there is provided a method of causing a subtitle information transmission apparatus and a subtitle information processing apparatus to cooperate with each other, the method which comprises: causing the subtitle information transmission apparatus to perform a control of reproducing a video signal which includes subtitle information, separating text of subtitle information from the video signal, and transmitting the text of subtitle information in stream form to the outside; and causing the subtitle information processing apparatus to perform a control of holding the text of subtitle information received from the subtitle information transmission apparatus, selecting the held text on a word basis, searching a dictionary for the selected word, and displaying the search result.

In the subtitle information transmission apparatus, subtitle information processing apparatus, and method of causing these apparatuses to cooperate with each other, the text of subtitle information separated from the video signal is transmitted in stream form to the outside. In this case, the operation of inputting characters for dictionary search can be eliminated by selecting the text of subtitle information on a word basis and searching the dictionary for the meaning of the selected word. That is, the subtitle information obtained from the video signal can be used effectively.

Hereinafter, a subtitle information processing system according to a first embodiment of the invention will be explained.

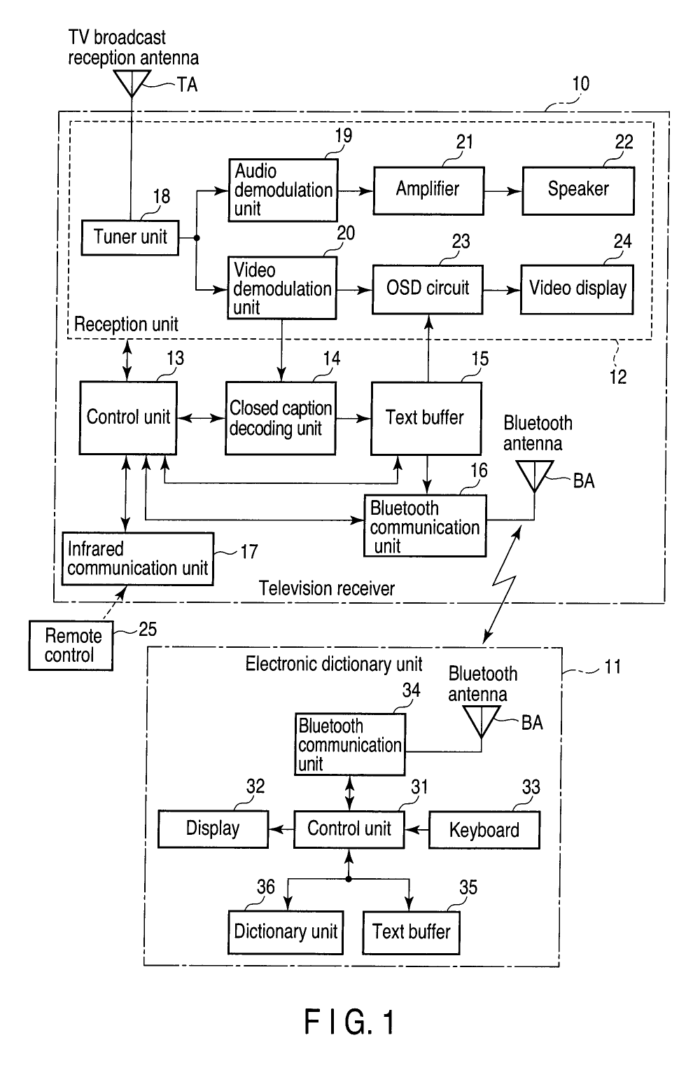

FIG. 1 shows an example of the configuration of the subtitle information processing system. The subtitle information processing system comprises a television receiver 10 provided as a subtitle information transmission apparatus and an electronic dictionary unit 11 provided as a subtitle information processing apparatus.

The television receiver 10 includes a TV broadcast reception antenna TA, a reception unit 12, a control unit 13, a closed caption decoding unit 14, a text buffer (memory) 15, a Bluetooth (registered trademark) communication unit 16, an infrared communication unit 17, and a Bluetooth antenna BA. The TV broadcast reception antenna TA receives TV broadcast waves. A broadcast wave is such that digital text, subtitle information on closed captions, is inserted into a video signal during the vertical blanking period of the video signal and the resulting video signal is transmitted in the form of a broadcast wave. The reception unit 12, which reproduces a video signal from the broadcast wave received by the TV broadcast reception antenna TA, includes a tuner unit 18, an audio demodulation unit 19, a video demodulation unit 20, an amplifier 21, a speaker 22, an on-screen display (OSD) circuit 23, and a video display 24. The tuner unit 18 selects one of the broadcast waves received by the TV broadcast reception antenna TA and outputs the selected wave as a received signal to the audio demodulation unit 19 and video demodulation unit 20. The audio demodulation unit 19 demodulates an audio signal from the received signal. The audio signal is amplified at the amplifier 21 and output as sound from the speaker 22. The video demodulation unit demodulates a video signal from the received signal and further acquires image information and subtitle information from the video signal. The image information is obtained during the effective scanning line period of the video signal and the subtitle information is obtained in the vertical blanking period of the video signal. The image signal is output to an OSD circuit 23 and the subtitle information is output to the closed caption decoding unit 14. The OSD circuit 23 performs a superimpose process of superimposing the text held in the text buffer 15 on image information on the video display 24. The video display 24 displays the result of the superimposition as an image.

The control unit 13 is composed of a CPU which performs various control processes, a ROM which holds a control program for the CPU and initial data, and a RAM which holds input and output data for the CPU. The control unit 13 controls the reception unit 12, closed caption decoding unit 14, text buffer 15, Bluetooth communication unit 16, and infrared communication unit 17 so as to perform control necessary for the operation of the entire television receiver. The closed caption decoding unit 14 decodes the subtitle information from the video demodulation unit 20, separates text on a line basis, and stores the texts into the text buffer 15. The text buffer 15 holds the line texts in ring buffer form. The Bluetooth communication unit 16, which complies with the Serial Port Profile (SPP) specification of the Bluetooth technology standard, transmits the contents of the text buffer 15 from the Bluetooth antenna BA by the data transmission method determined in the SPP specification. The infrared communication unit 17 receives an infrared signal transmitted from an infrared remote control 25 operated by the user and inputs the various commands superimposed on the infrared signal to the control unit 13.

The electronic dictionary unit 11 includes a control unit 31, a liquid-crystal display 32, a keyboard 33, a Bluetooth communication unit 34, a text buffer (memory) 35, a dictionary unit 36, and a Bluetooth antenna BA. The control unit 31 is composed of a CPU which carries out various control processes, a ROM which stores a control program for the CPU and initial data, and a RAM which holds input and output data for the CPU. The control unit 31 controls the liquid-crystal display 32, keyboard 33, Bluetooth communication unit 34, text buffer 35, and dictionary unit 36 so as to perform control necessary for the operation of the entire electronic dictionary unit. The dictionary unit 36 holds a dictionary containing the meanings and usages of various words. The keyboard 33 is operated to select a dictionary search word, change display modes, or the like. In the keyboard 32, for example, cursor-movement keys, including an [Upward shift] key, [Downward shift] key, [Left shift] key, and [Right shift] key, [Enter] key, [Return] key, and others are provided together with normal keys necessary for an electronic dictionary. The Bluetooth communication unit 34 outputs to the control unit 31 the text of subtitle information transmitted from the television receiver 10 by the data transmission method determined in the SPP specification and received by the Bluetooth antenna BA. The control unit 31 stores the text into the text buffer 35 on a line basis. The text buffer 35 holds the line texts in ring buffer form. When the keyboard 33 has been operated to select a dictionary search word, the control unit 31 selects the text held in the text buffer 35 on a word basis according to the operation of the keyboard 33 and searches the dictionary of the dictionary unit 36 for the meaning and usage of the selected word. The liquid-crystal display 32 is set to either the scroll display mode or translation display mode. The liquid-crystal display 32 displays the text held in the text buffer 35 in the scroll display mode or the meaning and usage of the word obtained as a result of searching the dictionary in the translation display mode.

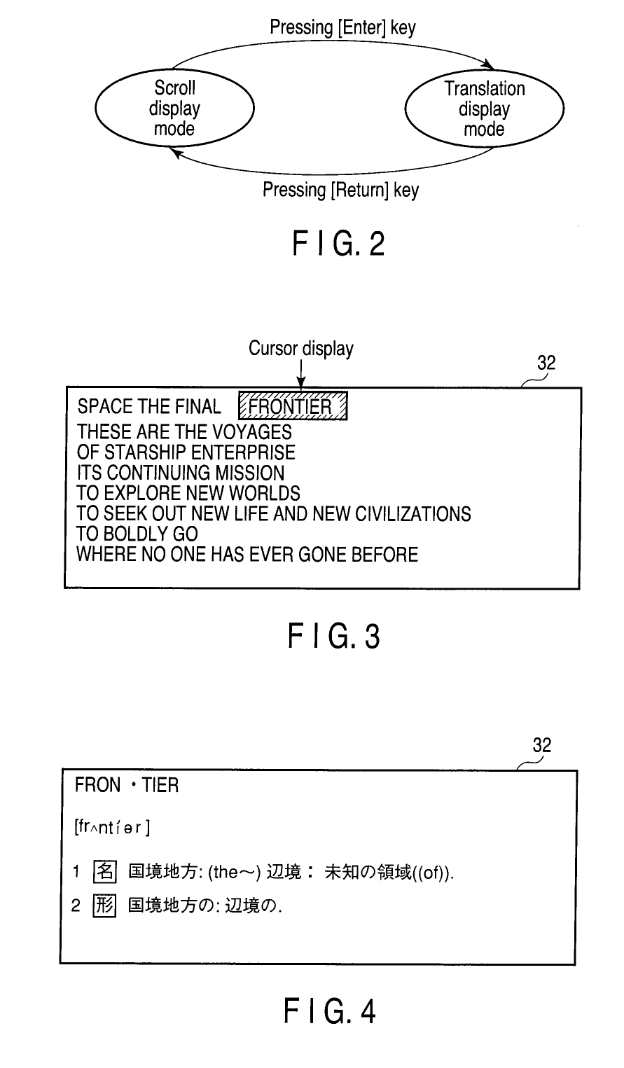

FIG. 2 shows the transition between display modes of the liquid-crystal display 32. The liquid-crystal display 32 is in the scroll display mode before dictionary search. In the scroll display mode, the text held in the text buffer 35 is displayed on a line basis as shown in FIG. 3. When one line of new text is added to the text buffer 35, the entire display text scrolls up by one line and the new text is displayed as the last line. On the liquid-crystal display 32, a cursor capable of moving upward, downward, rightward, or leftward according to the operation of the cursor movement keys is displayed to specify a word to be selected. With the cursor pointing at the word, when the [Enter] key is pressed, the control unit 31 selects the word specified by the cursor, consults the dictionary for the selected word, and changes the display mode of the liquid-crystal display 32 to the translation display mode in which the result of searching the dictionary is displayed. As a result, the meaning and usage of the word obtained as a result of searching the dictionary are displayed on the liquid-crystal display 32 as shown in FIG. 4. After the dictionary search result has been recognized, when the [Return] key is pressed, the liquid-crystal display 32 returns to the scroll display mode, which enables a word to be selected again.

In the first embodiment, the text of subtitle information separated from the video signal is transmitted in stream form from the television receiver 10 to the outside. In this case, the electronic dictionary unit 11 selects text of subtitle information on a word basis and searches the dictionary for the meaning of the selected word. This makes it possible to eliminate the operation of inputting characters to search the dictionary. That is, the subtitle information obtained from the video signal can be used effectively. Accordingly, the cooperation between the television receiver 10 and electronic dictionary unit 11 enables the convenience of the electronic dictionary unit 11 to be enhanced remarkably.

Next, a subtitle information processing system according to a second embodiment of the invention will be explained with reference to the accompanying drawings.

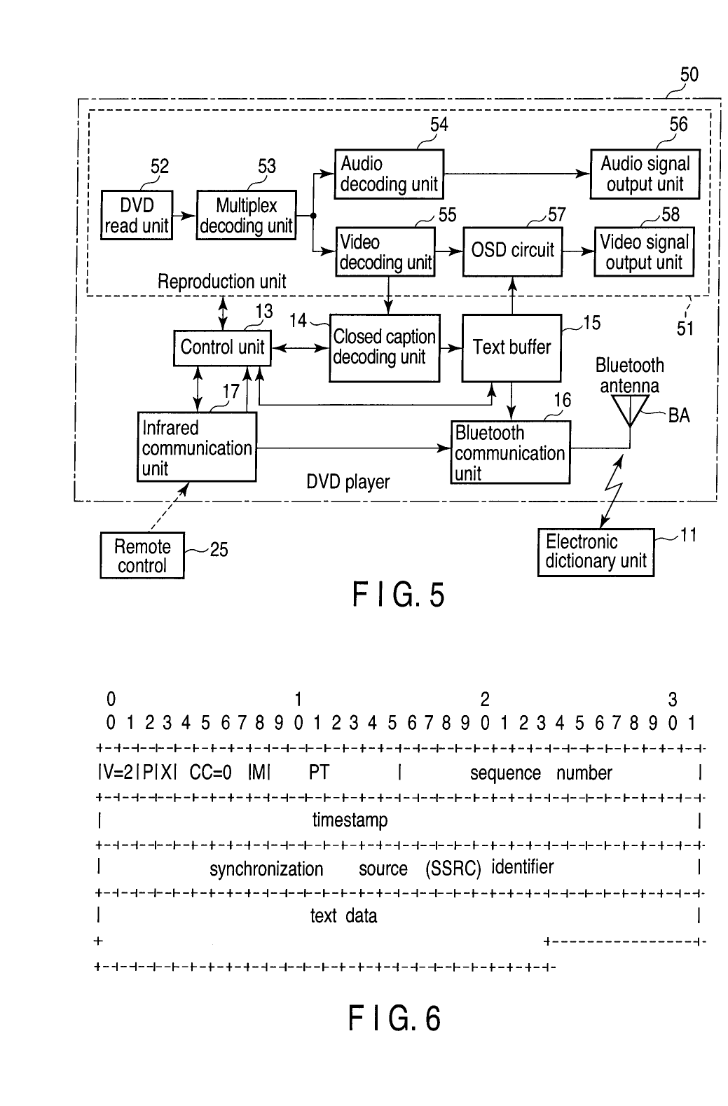

FIG. 5 shows an example of the configuration of the subtitle information processing system according to the second embodiment. The subtitle information processing system comprises a DVD player 50 provided as a subtitle information transmission apparatus and an electronic dictionary unit 11 provided as a subtitle information processing apparatus. The electronic dictionary unit 11 is almost the same as the one shown in FIG. 1. In FIG. 5, the same parts as those in the first embodiment are indicated by the same reference numerals.

The DVD player 50 includes a reproduction unit 51, a control unit 13, a closed caption decoding unit 14, a text buffer (memory) 15, a Bluetooth communication unit 16, an infrared communication unit 17, and a Bluetooth antenna BA. In a video signal of the contents recorded on a DVD, digital text, subtitle information for closed captions, has been inserted. Specifically, the text has been encoded into the user data area in a MPEG2 video bitstream to be turned into a video signal. The reproduction unit 51, which reproduces a video signal from such a DVD, includes a DVD read unit 52, a multiplex decoding unit 53, an audio decoding unit 54, a video decoding unit 55, an audio signal output unit 56, an on-screen display (OSD) circuit 57, and a video signal output unit 58. The DVD read unit 52 reads a content signal from the DVD and outputs the content signal to the audio decoding unit 54 and video decoding unit 55. The audio decoding unit 54 decodes an audio signal included in the content signal. The result of decoding the audio signal is output via the audio signal output unit. The video decoding unit 55 decodes a video signal included in the content signal and acquires image information and subtitle information from the video signal obtained from the decoding result. The image information is output to the OSD circuit 57 and the subtitle information is output to the closed caption decoding unit 14. The OSD circuit 57 superimposes the text held in the text buffer 15 onto image information and outputs the result of the superimposition via the video signal output unit 58.

The control unit 13 is composed of a CPU which performs various control processes, a ROM which holds a control program for the CPU and initial data, and a RAM which holds input and output data for the CPU. The control unit 13 controls the reproduction unit 51, closed caption decoding unit 14, text buffer 15, Bluetooth communication unit 16, and infrared communication unit 17 so as to perform control necessary for the operation of the entire DVD player. The closed caption decoding unit 14 decodes the subtitle information from the video decoding unit 55, separates text on a line basis, and stores the texts into the text buffer 15. The text buffer 15 holds the line texts in ring buffer form. The infrared communication unit 17 receives an infrared signal transmitted from an infrared remote control 25 operated by the user and inputs the various commands superimposed on the infrared signal to the control unit 13. The Bluetooth communication unit 16, which complies with the Serial Port Profile (SPP) specification of the Bluetooth technology standard, transmits the contents of the text buffer 15 from the Bluetooth antenna BA by the data transmission method determined in the SPP specification. The Bluetooth communication unit 16, which also complies with the A/V Remote Control Profile (AVRCP) specification of the Bluetooth technology standard, functions as an AVRCP-TG (target) device. When having received a remote control command from a Bluetooth communication partner, the control unit 13 controls the reproduction unit 51 according to the remote control command from the Bluetooth communication unit 16. Since the Bluetooth communication unit 34 of the electronic dictionary unit 11 is a communication partner of the Bluetooth communication unit 16, it also conforms to the AVRCP specification of the Bluetooth technology standard and functions as an AVRCP-CT (controller) device.

In the electronic dictionary unit 11, the liquid-crystal display 32 is in the scroll display mode before dictionary search. In the scroll display mode, the text held in the text buffer 35 is displayed on a line basis. When one line of new text is added to the text buffer 35, the entire display text scrolls up by one line and the new text is displayed as the last line. On the liquid-crystal display 32, a cursor capable of moving upward, downward, rightward, or leftward according to the operation of the cursor movement keys is displayed to specify a word to be selected. With the cursor pointing at the word, when the [Enter] key is pressed, the control unit 31 selects the word specified by the cursor, consults the dictionary for the selected word, and changes the display mode of the liquid-crystal display 32 to the translation display mode in which the result of searching the dictionary is displayed. Then, the meaning and usage of the word obtained as a result of searching the dictionary are displayed on the liquid-crystal display 32 as shown in FIG. 4. At this time, the control unit 31 requests the Bluetooth communication unit 34 to issue a pause command. Then, the Bluetooth communication unit 34 issues a pause command determined in the AVRCP specification to the Bluetooth communication unit 16, a communication partner on the DVD player 50 side. After the dictionary search result has been recognized, when the [Return] key is pressed, the liquid-crystal display 32 returns to the scroll display mode, which enables a word to be selected again. At this time, the control unit 31 requests the Bluetooth communication unit 34 to issue a play command. Then, the Bluetooth communication unit 34 issues a play command determined in the AVRCP specification to the Bluetooth communication unit 16, a communication partner on the DVD player 50 side.

In the second embodiment, the text of subtitle information separated from the video signal is transmitted in stream form from the DVD player 50 to the outside. In this case, the electronic dictionary unit 11 selects text of subtitle information on a word basis and searches the dictionary for the meaning of the selected word. This makes it possible to eliminate the operation of inputting characters to search the dictionary. That is, the subtitle information obtained from the video signal can be used effectively. Moreover, the operation of reproducing the video signal at the reproduction unit 51 of the DVD player 50 is stopped temporarily by the command from the electronic dictionary unit 11, which prevents the displayed image from advancing while the dictionary search result is being checked. Accordingly, the cooperation between the DVD player 50 and electronic dictionary unit 11 enables the convenience of the electronic dictionary unit 11 to be enhanced remarkably.

Next, a subtitle information processing system according to a third embodiment of the invention will be explained with reference to the accompanying drawings.

The subtitle information processing system has the same configuration as that of the second embodiment shown in FIG. 5, except that text of subtitle information is transmitted using the AV Distribution Transport Protocol (AVDTP), not the SPP, in the Bluetooth communication between the DVD player 50 and the electronic dictionary unit 11. For this reason, the Bluetooth communication unit 16 of the DVD player 50 has an AVDTP source function and the Bluetooth communication unit 34 of the electronic dictionary unit 11 has an AVDTP sink function. In the DVD player 50 and electronic dictionary unit 11, text is caused to correspond to time information and the resulting text is stored into the text buffers 15 and 35. The time information indicates the time at which the text is to be displayed on the display screen, using one frame of a video signal as one unit and setting the start time of the video signal as 0.

The Bluetooth communication unit 16 of the DVD player 50 generates AVDTP packets in a format shown in FIG. 6 and transmits them to the electronic dictionary unit 11 by a Bluetooth link. Here, the text in the text buffer 15 is substituted into a text data field and the time information is substituted into a time stamp field. Values determined in the RFC3550 specification are substituted into the other fields. When the Bluetooth communication unit 34 of the electronic dictionary unit 11 has received the AVDTP packets of the format shown in FIG. 6, they are held in the text buffer 35.

As a result of the transition from the scroll display mode to the translation display mode, the control unit 31 of the electronic dictionary unit 11 outputs a VendorDependent command issue request to the Bluetooth communication unit 34. As OperationData for a VendorDependent command, time information for the word existing in the text buffer 35 so as to correspond to the cursor display position is set. When having received the request, the Bluetooth communication unit 34 issues a VenderDependent command determined in the AVRCP specification to the Bluetooth communication unit 16 of the DVD player 50 and adds the OperationData given at this time to the command. When the Bluetooth communication unit 16 of the DVD player 50 has received the VenderDependent command from the electronic dictionary unit 11, the reading position of a DVD reading unit 52 is moved to the time in the time information written in the OperationData.

In the third embodiment, after the dictionary search result has been checked at the electronic dictionary unit 11, the DVD reading position is returned to the time corresponding to the word selected for the dictionary search. Accordingly, the third embodiment produces the same effect as the second embodiment.

Next, a subtitle information processing system according to a fourth embodiment of the invention will be explained with reference to the accompanying drawings.

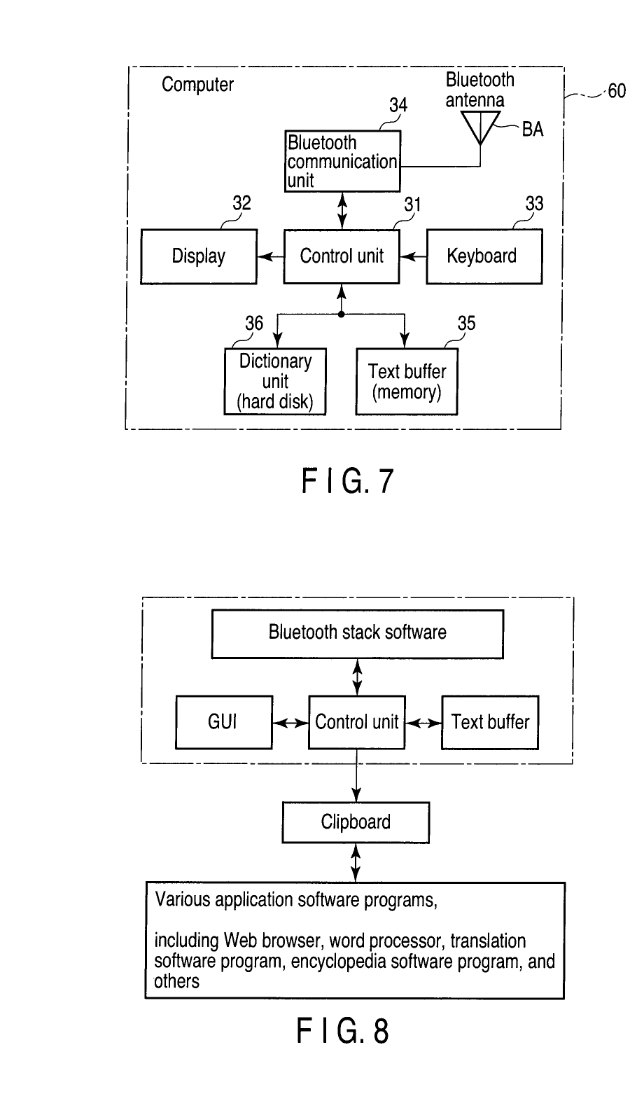

In the subtitle information processing system, the television receiver 10 of FIG. 1 or the DVD player 50 of FIG. 5 is provided as a subtitle information transmission apparatus and a personal computer 60 shown in FIG. 7 is provided as a subtitle information processing apparatus. The personal computer 60 has basically the same hardware configuration as the electronic dictionary unit 11 of FIG. 1. Specifically, the main part of the personal computer 60 includes a CPU, a memory, and a hard disk. The CPU constitutes a control unit 31, the memory constitutes a text buffer 35, and the hard disk constitutes a dictionary unit 36. Moreover, a display 32 and a keyboard 33 are provided as a graphic user interface (GUI) as in the electronic dictionary unit 11.

The CPU, or control unit 31, of the personal computer 60 executes software configured as shown in FIG. 8. Bluetooth stack software is a software module to realize the SPP. As for the GUI, a text scroll display as shown in FIG. 3 and a cursor display are realized. When the user presses Enter key on the keyboard, the word in the cursor position is copied as text data onto the clipboard. The text data is offered from the clipboard to application software, such as a Web browser, a word processor, a translation software program, or an encyclopedias software program.

In the fourth embodiment, the personal computer 60 is provided as the subtitle information processing apparatus. Since the personal computer 60 can operate in the same manner as the electronic dictionary unit 11 of FIG. 11, the fourth embodiment produces the same effects as the first to third embodiments.

This invention is not limited to the above embodiments and may be practiced or embodied in still other ways without departing from the spirit or essential character thereof.

While in the above embodiments, a dictionary search word is selected at the subtitle information processing apparatus, it may be selected on the subtitle information transmission apparatus. Specifically, the subtitle information text held in the text buffer 35 and displayed on the subtitle information transmission apparatus side is selected on a word basis by the operation of the remote control 25 and the selected text is transmitted by the Bluetooth link. In this case, the subtitle information processing apparatus searches the dictionary for the text transmitted on a word basis from the subtitle information transmission apparatus.

As a concrete example, if the television receiver or DVD player is provided as a subtitle information transmission apparatus and the electronic dictionary unit is provided as a subtitle information processing apparatus, the cooperation between them makes it possible to enhance the convenience of the electronic dictionary unit remarkably.

In the first embodiment, the subtitle information transmission apparatus has been composed of the television receiver 10. If the television receiver 10 is provided with a recording hard disk drive and a video signal of the content recorded at the hard disk drive is reproduced, the subtitle information text displayed on the video display 24 is selected on a word basis for dictionary search by the operation of the remote control 25. At this time, the reproduction of the video signal is stopped temporarily, which prevents the displayed image from advancing.

Furthermore, while in the first to fourth embodiments, the subtitle information has been closed captions, the subtitle information may be subtitles in various languages added to such content as the movies.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A subtitle information transmission apparatus comprising:
a signal reproduction unit which reproduces a video signal including subtitle information;
a separation unit which separates text of subtitle information from the video signal; and
a short-range wireless communication unit which transmits in stream form the text of subtitle information separated by the separation unit to the outside.

2. The apparatus according to claim 1, further comprising a control unit which controls the reproduction and stop of the signal reproduction unit according to a request received by the short-range wireless communication unit.

3. The apparatus according to claim 2, wherein the control unit controls the return of the reproduction position of the signal reproduction unit according to a request received by the short-range wireless communication unit.

4. The apparatus according to claim 2, wherein the control unit selects, on a word basis, the text of subtitle information obtained from the separation unit and causes the short-range wireless communication unit to transmit a result of the selection.

5. The apparatus according to claim 1, which is provided as a television receiver or a DVD player.

6. A subtitle information processing apparatus comprising:
a short-range wireless communication unit which receives text of subtitle information separated from a video signal and transmitted in stream form;
a memory unit which holds the text of subtitle information received by the short-range wireless communication unit;
a display unit which displays the text held in the memory unit;
an operation unit which selects, on a word basis, the text displayed on the display unit;
a dictionary unit which holds a dictionary; and
a processing unit which searches the dictionary of the dictionary unit for the meaning of the word selected by the operation unit and causes the display unit to display a result of the search.

7. The apparatus according to claim 6, wherein the processing unit causes the short-range wireless communication unit to transmit a video signal reproduction stop request when the search result is displayed.

8. The apparatus according to claim 7, wherein the processing unit causes the short-range wireless communication unit to transmit a video signal reproduction request after the search result is displayed.

9. The subtitle information processing apparatus according to claim 6, wherein the processing unit causes the short-range wireless communication unit to transmit a video signal reproduction position return request after the search result is displayed.

10. The subtitle information processing apparatus according to claim 6, which is provided as a computer having an electronic dictionary unit or a dictionary function.

11. A method of causing a subtitle information transmission apparatus and a subtitle information processing apparatus to cooperate with each other, the method comprising:
causing the subtitle information transmission apparatus to perform a control of reproducing a video signal which includes subtitle information, separating text of subtitle information from the video signal, and transmitting the text of subtitle information in stream form to the outside; and
causing the subtitle information processing apparatus to perform a control of holding the text of subtitle information received from the subtitle information transmission apparatus, selecting the held text on a word basis, searching a dictionary for the selected word, and displaying the search result.
